(19) United States
(12) Patent Application Publication
(10) Pub. No.: US 2019/0184489 A1
(43) Pub. Date: Jun. 20, 2019

(54) METHOD FOR JOINING COMPONENTS AND DEVICE

(71) Applicant: Rolls-Royce Deutschland Ltd & Co KG, Blankenfelde-Mahlow (DE)

(72) Inventors: Bjoern ULRICHSOHN, Dresden (DE); Bjoern HINZE, Berlin (DE)

(21) Appl. No.: 16/224,144

(22) Filed: Dec. 18, 2018

(30) Foreign Application Priority Data
Dec. 20, 2017 (DE) 10 2017 223 410.5

(51) Int. Cl. B23K 20/12; B23K 26/323; B23K 26/24; F01D 9/04

(52) U.S. Cl. CPC B23K 20/129; B23K 26/323; B23K 2101/001; F01D 9/041; F05D 2230/239; B23K 26/24

(57) ABSTRACT

A method for connecting components, including the following steps: providing a first component, including or composed of a first material; providing at least one second component, including or composed of a second material; applying an intermediate layer to the second component by means of generative manufacture, in particular by deposition welding; and connecting the intermediate layer on the second component to the first component by means of welding, in particular friction welding. The invention also relates to a corresponding device.

The invention relates to a method for joining components according to Claim 1, and to a device according to Claims 13 and 14.

In the aviation engineering sector in particular, there is a demand for extremely high-performance components which should simultaneously have as low a weight as possible. Here, high-strength metal alloys are being developed, in particular nickel-based alloys. There is however the difficulty here that particularly high-performance alloys are often not weldable, or are weldable only with unsatisfactory quality. Positively locking connections are therefore often resorted to for connecting multiple components to one another. For example, two components may be screwed together by means of a bolt and a nut.

This problem has particular relevance in the case of blade rings in turbomachines. There, a multiplicity of blade airfoils is generally connected to a ring or a disk. If each of these connections is produced by means of a bolt and a nut, a not inconsiderable part of the weight of the blade ring is attributed to the connections. It is also known for a blade ring to be produced in one piece together with blade airfoils in a casting process. Here, however, complex blade geometries can be realized only with difficulty, and it is not possible to use different materials for the ring or the disk, on the one hand, and the blade airfoils, on the other hand. In particular in the hot environment of a turbine, it may however be necessary to provide different materials.

If the components of the blade ring are to be welded to one another, for example by means of friction welding or electron beam welding, some materials and material combinations therefore cannot normally be used. In particular, certain advantageous material combinations have hitherto not been connectable by means of friction welding. For example, material combinations with high-strength and particularly temperature-stable metal alloys, for example certain nickel-based alloys, are not suitable for friction welding. Friction welding is however an advantageous welding method because, by contrast to other welding methods, there is not the risk of pore formation which impairs the stability of the device to be produced.

DE 44 09 769 A1 describes the application of intermediate layers composed of aluminum, copper or nickel to joining surfaces of blades composed of ceramic material, for example by galvanization. The blades are connected to hubs for example by means of friction welding.

DE 10 2008 052 247 A1 describes a component of a gas turbine, which component comprises a rotor main body composed of a high-temperature nickel alloy and a multiplicity of turbine blades composed of a titanium alloy. A blade root is formed as an adapter element which is composed of a material which is weldable both to the titanium alloy and to the high-temperature nickel alloy.

The known devices and methods are however not suitable for numerous material combinations.

It is the object to provide an improved method for joining components, in particular a method which makes it possible to securely connect particularly high-performance material combinations to one another without considerably increasing the weight, and a device having correspondingly connected components.

The object is achieved by a method for joining components having the features of Claim 1.

In said method, the following steps are provided: providing a first component, which (at least predominantly) is composed of a first material or comprises the first material (the first material may in particular be a weldable material); providing at least one second component which (at least predominantly) is composed of a second material or comprises the second material (the second material may be a non-weldable, in particular non-friction-weldable material); applying an intermediate layer to the at least one second component by means of generative manufacture, in particular by deposition welding (also referred to as laser cladding); and connecting the intermediate layer applied to the at least one second component to the first component by means of welding, in particular by means of friction welding, in order to produce a cohesive connection of the first to the at least one second component.

This is based on the realization that some metal alloys (in particular materials with a high gamma prime fraction) cannot be satisfactorily welded (in particular by means of friction welding) because, in these processes, an excessive introduction of energy would impair the material structure of the alloys. The first and second materials may furthermore greatly differ from one another in terms of their characteristics. Here, it may occur that there are no suitable parameters for the material pairing that would permit conventional welding. In particular, fractures or cracks may arise in instances of excessive introduction of energy. Furthermore, the outlay for a testing method with which the load capacity of a connection thus produced is tested would be very great.

By contrast, in the case of deposition welding, only relatively very low amounts of energy can be introduced into the material of the components to be connected. The intermediate layer may, for example in multiple passes, be applied as a coating to the (otherwise non-friction-weldable) second component. The material may be applied in a multiplicity of layers. The intermediate layer provides a connection region for the connection to the first component.

Thus, a method for producing a friction-welded connection is provided with which it is possible for two components to be connected to one another by friction welding even though at least one of the components (before the application of the intermediate layer) is not, or is not satisfactorily, weldable, in particular friction-weldable. The proposed method is thus improved in particular so as to create the possibility of cohesively connecting entirely new material combinations.

The first material may be the same material as the second material. In particular, provision may however be made for the first material to differ from the second material. For example, the first material is a (friction-)weldable material, whereas the second material is one which is not weldable (in particular is not connectable, or is not satisfactorily connectable, by means of friction welding to another component). In particular, provision may be made for the first component not to comprise the second material, and/or for the second component not to comprise the first material.

In one refinement, the intermediate layer comprises the first material or is composed of the first material. The first material is in particular then a (friction-)weldable material. In this way, it is possible for two components which are in fact not (friction-)weldable to be connected by means of welding, in particular friction welding, without the use of a third material. Alternatively, the intermediate layer is produced from a (third) material, which is for example more similar to the first material than the second material.

The first material and the second material may each be a (for example high-temperature) metal alloy, in particular a nickel alloy. It is preferable for at least one of the first and the second component to comprise, or be composed of, a nickel-based alloy. In particular, all of the components may be composed of a nickel-based alloy or comprise such a nickel-based alloy. The first material and the second material may thus comprise different nickel alloys, in particular nickel-based alloys, or be composed of different nickel alloys, in particular nickel-based alloys. For example, the first and/or the second material has nickel as a main component and chromium as a secondary component with the highest fraction. The first material is for example a (friction-weldable) polycrystalline nickel alloy. Deposition welding is suitable in particular for so-called superalloys. The second material in particular may be an alloy of said type. The second material may also be a polycrystalline alloy, or may alternatively be present in the form of single crystals. Such alloys have particularly high strength and/or are particularly temperature-resistant. Owing to high gamma prime fractions, friction welding has hitherto not been possible, or has not been satisfactorily possible.

The first material may for example be Inconel-718. The second material is for example CMSX-4, Udimet or RR1000. Such materials exhibit particularly good characteristics.

The generative manufacture may be in particular a laser deposition welding method. Laser deposition welding is very highly suitable for the processing of nickel-based alloys, and yields particularly good connections.

It is possible for multiple second components to be provided, wherein an intermediate layer is applied to each of the second components by means of generative manufacture, in particular by means of deposition welding, and the intermediate layer of each of the second components is connected by means of welding, in particular by means of friction welding, to the first component. It is thus possible for complex devices to be produced in an efficient and reliable manner, wherein optimized materials are connected without bolts or the like.

The method optionally comprises a step of weld aftertreatment which follows the step of friction welding. The weld aftertreatment comprises in particular a tempering or heat treatment of the interconnected components. By means of the weld aftertreatment, the quality of the welded connection can be increased.

The provision of the first component may comprise the forging of the first component. The first component is then thus a forged component.

In one refinement, the first component constitutes a blade carrier for a turbomachine, or a part of a blade carrier of said type.

At least one second component is for example a blade airfoil for a turbomachine or a further part of the blade carrier. In this way, the blade airfoil can be mounted particularly securely on the blade carrier. Blade airfoils for turbomachines often have particularly specific material requirements, and it has hitherto generally be necessary for the blade airfoils to be fastened for example by means of screw connections, which however generally greatly increase the weight of the device.

The method according to any refinement described herein may be configured for producing a blade ring for a turbomachine, wherein the first component is provided in the form of a ring or a disk of a turbomachine, and the at least one second component is provided in the form of a blade, in particular of a compressor blade or of a turbine blade. It is thus possible to produce a particularly robust blade ring which may furthermore have a particularly low weight, because additional connecting devices, for example connections in the form of a dovetail connection, are not necessary. Since the blade rings may be parts which rotate during the operation of the turbomachine (for example in the form of a gas turbine), a weight saving has a pronounced effect.

The above object is also achieved by means of a device having the features of Claim 13. The device is in particular produced or producible by means of the method according to any refinement described herein. The device may comprise the following:
a first component, comprising or composed of a first material;
at least one second component, comprising or composed of a second material;
an intermediate layer applied to the second component by generative manufacture, in particular by deposition welding; and
a welded connection, in particular in the form of a friction-welded connection, that is to say friction-weld seam, which cohesively connects the intermediate layer (12) on the second component (11, 11A) to the first component (10, 10A, 10B).

The welded connection, for example in the form of a friction-weld seam, covers the intermediate layer in particular completely or almost completely, for example at least in two spatial directions.

The above object is also achieved by means of a device having the features of Claim 14. Accordingly, the device has the following: a first component or a first portion, comprising or composed of a first material, and a second component or a second portion, comprising or composed of a second material, which is in particular different from the first material. The first material of the first component or portion is cohesively connected to the second material of the second component or portion by means of an intermediate layer and a further layer, in particular in the form of a friction-welded layer. The intermediate layer is arranged adjacent to the second component or portion and has a first grain size (the grain is in particular coarse-grained and/or directional). The further layer is arranged between the intermediate layer and the first component or portion and has a second grain size smaller than the first grain size. The first material has a third grain size smaller than the first grain size and larger than the second grain size.

The intermediate layer is uniquely identifiable from its characteristic form superficially and in cross section, in particular from weld beads resulting from the deposition welding. Furthermore, the grain sizes of the materials are measurable.

The device may be in the form of a blade ring for a turbomachine and comprise multiple second components in the form of in each case one blade airfoil.

With regard to the other possible designs of the first and second component and with regard to the corresponding advantages, reference is made to the above statements relating to the method for connecting the components and for producing the blade ring. In particular, the first material may be a friction-weldable metal alloy, in particular a nickel-based alloy, and the second material may be a nickel-based alloy, in particular with a high gamma prime fraction, for example a so-called superalloy, for example CMSX-4, Udimet or RR1000.

The invention will be discussed in connection with the exemplary embodiments illustrated in the figures. In the figures:

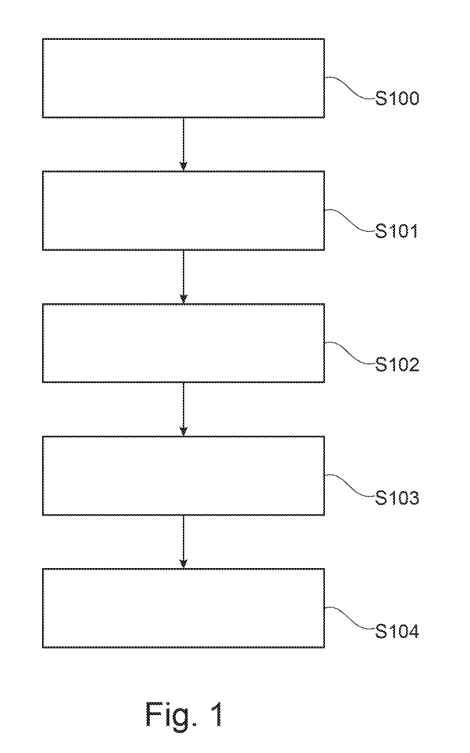

FIG. 1 shows a method for joining components;

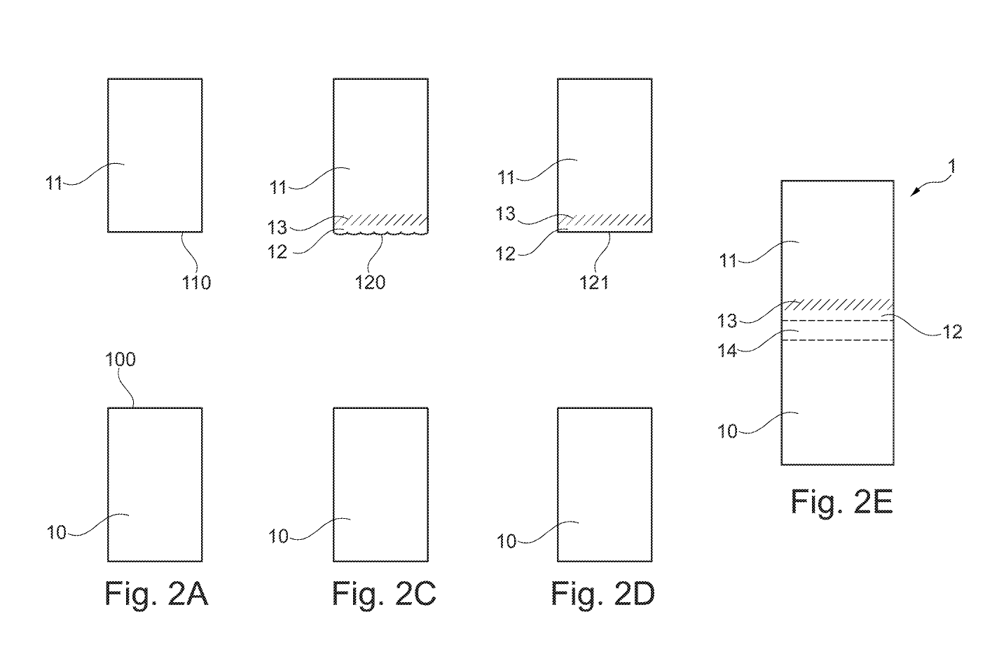

FIGS. 2A-2E show schematic cross-sectional illustrations of a first and of a second component, in various stages of the production of a connection of the two components;

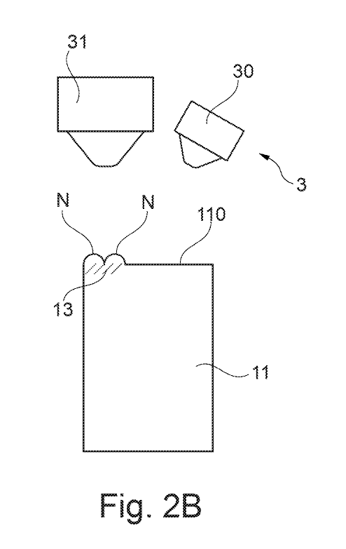

FIG. 3 shows a schematic sectional illustration of a blade ring for a gas turbine having a first component and multiple second components;

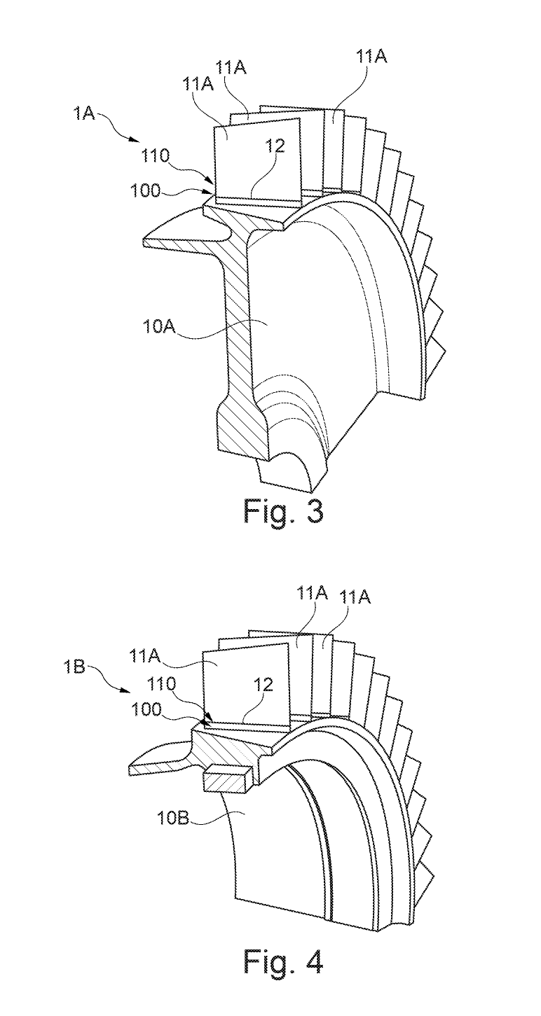

FIG. 4 shows a schematic sectional illustration of a further blade ring for a gas turbine having a first component and multiple second components; and

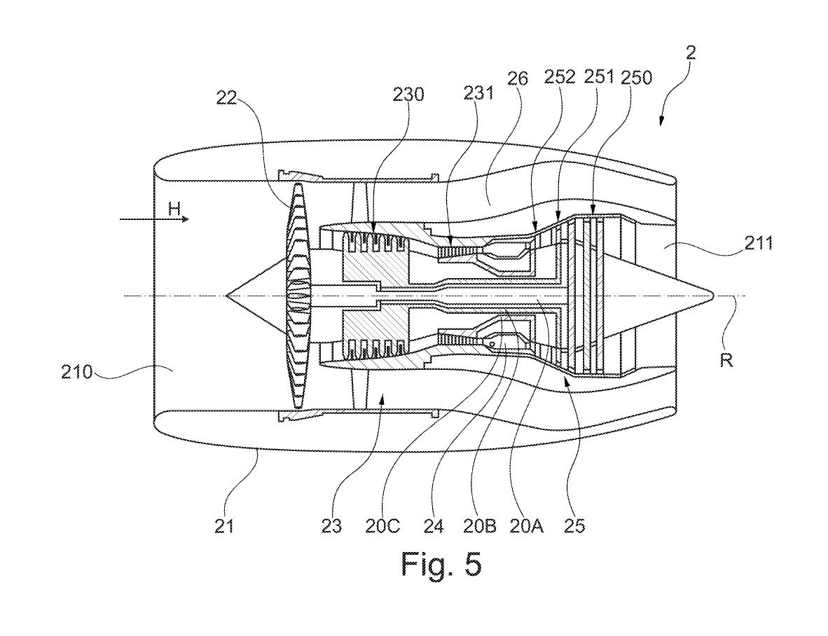

FIG. 5 shows a schematic sectional illustration of a gas turbine having a fan, having a compressor and having a turbine with multiple blade rings.

FIG. 1 shows multiple method steps S100-S104 of a method for connecting, specifically for joining, two or more components.

FIGS. 2A to 2E show a first component 10 and a second component 11 in multiple stages during the method as per FIG. 1.

In a first step S100, a first component 10 is provided. The first component 10 comprises at least one connection region 100, optionally a multiplicity of connection regions 100. As illustrated in FIG. 2A, the connection region 100 is a part of the surface of the first component 10, in particular but not imperatively in the form of a planar surface. The connection region 100 serves as joining surface. The first component 10 is composed (at least predominantly) of a first material, for example of a nickel-based alloy, in particular of Inconel, for example Inconel-718.

In a second step S101, at least one second component 11 is provided, optionally a multiplicity of second components 11. The or each second component 11 comprises at least one connection region 110. As shown in FIG. 2A, the connection region 110 is a part of the surface of the second component 11, in particular but not imperatively in the form of a planar surface. The connection region 110 serves as joining surface. The second component 11 is composed (at least predominantly) of a second material which differs from the first material. In other words, the first and the second component 10, 11 are composed of different materials. The second material is for example a nickel-based alloy such as for example CMSX-4, or alternatively Udimet or RR1000.

In a third step S102, an intermediate layer 12 is applied to the second component 11. The application of the intermediate layer 12 is performed on the connection region 110 of the second component 11. The application of the intermediate layer 12 is performed by means of deposition welding, in the present example by means of laser deposition welding. The intermediate layer 12 is applied in the form of a coating to the second component 11.

FIG. 2B shows the second component 11 and a welding device 3. Here, the welding device 3 comprises, by way of example, at least one powder feed means 30 and at least one laser 31. The welding device 3 is designed for laser deposition welding by means of powder.

By means of a relative movement between the welding device 3 and the second component 11, multiple deposition-weld seams N or beads are applied to the second component 11. By virtue of the powder applied by the powder feed means 30 to the second component being heated by means of laser light of the laser 31, the powder is at least partially melted, and the second material of the second component 11 is also partially melted. As a result, a cohesive connection forms between the deposition-weld seams N and the second component 11 and between adjacent deposition-weld seams N. Furthermore, a mixing zone 13 (illustrated by hatching in FIGS. 2B-2E) forms, in which the second material of the second component 11 and the material of the powder are mixed with one another. The material of the powder may for example be the first material, or alternatively a third material. The material of the powder differs from the second material.

A multiplicity of deposition-weld seams N is applied, such that the intermediate layer 12 forms, as shown in particular in FIG. 2C. The intermediate layer 12 extends for example over an entire width and/or depth of the second component 11. Alternatively, the intermediate layer may form a frame, for example in order to produce a connection which permits a feed of cooling air within a second component formed as a blade airfoil. The frame extends for example along the edges of the connection region 110.

As a result of the deposition welding, the intermediate layer 12 may initially have a surface with multiple undulations 120. Each of the undulations 120 corresponds to a weld bead as a result of the deposition welding. For the best possible connection to the first component 10, said undulations 120 may be milled away, in particular ground away or ground smooth. As a result of the grinding of the intermediate layer 12, the undulations 120 are removed, such that the intermediate layer has a ground, in particular planar surface 121, as illustrated in FIG. 2D.

At this stage, the second component 11 thus has the following portions: the original portion with or composed of the second material, the mixing zone 13 adjoining said original portion, and the intermediate layer 12, for example composed of the first material, on that side of the mixing zone 13 which is situated opposite the second material.

In a fourth step S103, the intermediate layer 12 arranged on the second component 11 is joined by means of friction welding to the first component 10. The ground surface 121 of the intermediate layer 12 and the connection region 100 of the first component 10 serve as contact surfaces. Here, the two components 10, 11 are moved relative to one another under pressure, wherein the components 10, 11 make contact at the contact surfaces.

As a result, an (areal) friction-weld seam 14 forms between the first material of the first component 10 and the intermediate layer 12, see FIG. 2E. The two components 10, 11 are then cohesively connected to form a device 1 (see in particular FIG. 2E).

The device 1 thus comprises a portion with the second material (of the second component 11). Said portion is adjoined by the mixing zone 13. The mixing zone 13 is adjoined (opposite the portion with the second material) by the intermediate layer 12. The material of the intermediate layer 12 is of coarse-grained form (large, first grain size). As a result of the deposition welding, the grain growth is directional, such that the grain of the material in the intermediate layer 12 is directional, for example, at least in portions, predominantly in a direction away from the portion with the second material. The intermediate layer 12 is adjoined (opposite the mixing zone 13) by the friction-weld seam 14. The friction-weld seam 14 is of fine-grained form (small, second grain size). The friction-weld seam 14 is adjoined (opposite the intermediate layer 12) by a portion with the first material (of the first component 10). The first material has a (medium-sized) third grain size which lies between the first and the second grain size. This material region may also be referred to as heat influence zone of the friction welding.

The thickness of the intermediate layer 12 and of the friction-weld seam 14 (as viewed in the direction from the first to the second material) may amount altogether to 0.5 to 10 mm, in particular 3 to 6 mm, for example 5 mm.

The thickness of the intermediate layer 12 (as viewed in the direction from the first to the second material) after the third step S102 and before the fourth step S103 may amount for example to 3 to 6 mm. After the fourth step S103, the thickness of the intermediate layer 12 is reduced by for example approximately 50%, and in particular still amounts to up to 2 mm.

The friction-weld seam 14 may be in the form of a plastically recrystallized microstructure.

The first component 10 may be for example a forged component. The first material may thus be present as a forged microstructure, in particular as a fine-grained forged microstructure.

The second component 11 may be in particular a cast component.

In an optional fifth step S104, a welding aftertreatment is performed, for example by heat treatment of the device 1 produced from (at least) the two interconnected components 10, 11. The heat treatment is configured and serves for forming hardening phases. If the first component 10 has already been welded, a common welding aftertreatment can be performed for the various weld seams, which permits a time saving.

The heat treatment is performed for example for 4 hours at 725° C. to 735° C. with controlled cooling (for example for Inconel-718 as the first material and CMSX-4 as the second material).

Alternatively or in addition to a heat treatment, the intermediate layer 12 and/or the friction-weld seam 14 are (laterally) ground, for example in order to produce a continuously smooth surface from the first component 10 to the second component 11.

FIGS. 3 and 4 show, in cut-away views, in each case one blade ring 1A, 1B for a turbomachine. The blade rings 1A, 1B are each of symmetrical form about a central axis which, in the installed state in the turbomachine, coincides with a central axis of rotation of the turbomachine.

The blade ring 1A as per FIG. 3 comprises a first component 10A in the form of a (circular or substantially circular) disk. The first component 10A serves as blade carrier. A multiplicity of second components 11A in the form of in each case one blade airfoil is provided on the first component 10A (on the outer circumference thereof). The first component 10A is cohesively connected to each of the second components 11A. The blade ring 1A is a so-called blisk (abbreviation for “blade integrated disk”).

The blade ring 1B as per FIG. 4 comprises a first component 10B in the form of a (circular or substantially circular) ring. The first component 10B serves as blade carrier. A multiplicity of second components 11A in the form of in each case one blade airfoil is provided on the first component 10B (on the outer circumference thereof). An arrangement along the inner circumference of the first component 10B is alternatively also possible. The first component 10B is cohesively connected to each of the second components 11A. The blade ring 1B is a so-called bling (abbreviation for “blade integrated ring”).

Particularly suitable materials for the blade rings 1A, 1B are nickel-based alloys. Nickel-based alloys are often only not satisfactorily weldable to one another, or not weldable to one another at all, for example by means of friction welding. Also, the technical demands on the material of the in each case first component 10A, 10B and on the second components 11A may differ from one another, such that one of the two materials is not weldable, or is only not satisfactorily weldable, by means of friction welding.

The cohesive connection of the in each case first component 10A, 10B of the blade rings 1A, 1B as per FIG. 3 and FIG. 4 to the respective second components 11A is formed by means of an intermediate layer 12 applied by means of deposition welding and a friction-welded layer (friction-weld seam 14) produced by means of friction welding, in the present case in the root or in the region of the root of the respective second component 11A. In particular if the connection region has not been ground, the intermediate layer 12 can be identified externally from the typical bead-like deposition-weld seams N. The deposition-weld seams N can also be identified in cross section from their typical shaping. Both the intermediate layer 12 and the friction-weld seam 14 can be identified from the grain of the respective material.

The first components 10A, 10B as per FIGS. 3 and 4 are connected to the second components 11A for example correspondingly to FIG. 2E, specifically by means of the method described in particular in conjunction with FIG. 1.

Alternatively or in addition, the first components 10A, 10B of the blade rings 1A, 1B may, as per FIGS. 3 and 4, be produced in multiple parts, wherein the multiple parts (of which in each case one constitutes a first component and one constitutes a second component, correspondingly to FIGS. 2A-2E) are cohesively connected to one another in accordance with the method as per FIG. 1. Furthermore, multiple blade rings 1A, 1B may function as first and second components and be cohesively connected to one another for example so as to be positioned axially one behind the other.

In the present case, the blade rings 1A, 1B as per FIGS. 3 and 4 are blade rings for a compressor of a turbomachine (in particular for the gas turbine 2, described below, as per FIG. 5). Correspondingly, it is self-evidently also possible for blade rings for a turbine of a turbomachine (in particular for the gas turbine 2, described below, as per FIG. 5) to be produced with a connection corresponding to FIG. 2E.

FIG. 5 shows a turbomachine embodied as a gas turbine 2 (in this case as an engine for an aircraft). The gas turbine 2 comprises multiple, in the present case three, shafts 20A, 20B, 20C which are rotatable about a common axis of rotation R. The shafts 20A, 20B, 20C are arranged within a housing 21 of the gas turbine 2. The housing 21 defines an air inlet 210 and an air outlet 211.

An air flow enters the gas turbine 2 through the air inlet 210. The gas turbine 2 has an axial main flow direction H. The main flow direction H runs substantially along the axis of rotation R of the shafts 20A, 20B, 20C. Downstream of the air inlet 210 as viewed in the direction of the main flow direction H, the gas turbine 2 comprises a fan 22, a compressor 23, a combustion chamber 24, a turbine 25 and the air outlet 211.

The gas turbine 2 is, in the present case, of three-stage design. One of the shafts 20A, 20B, 20C serves as low-pressure shaft 20A, one serves as medium-pressure shaft 20B, and one serves as high-pressure shaft 20C. Via the low-pressure shaft 20A, a low-pressure turbine 250 of the turbine 25 drives the fan 22. Via the medium-pressure shaft 20B, a medium-pressure turbine 251 drives a medium-pressure compressor 230 of the compressor 23. Via the high-pressure shaft 20C, a high-pressure turbine 252 of the turbine 25 drives a high-pressure compressor 231 of the compressor 23.

The fan 22 feeds air to a bypass channel 26 for the purposes of generating thrust. The fan 22 and a compressor 23 furthermore compress the air flow entering through the air inlet 210, and conduct said air flow along the main flow direction H into the combustion chamber 24 for the purposes of combustion. Hot combustion gases emerging from the combustion chamber 24 are expanded in the turbine 25 before emerging through a nozzle of the air outlet 211. The nozzle ensures a residual expansion of the emerging hot combustion gases and mixing with secondary air, wherein the emerging air flow is accelerated.

The compressor 23 and the turbine 25 of the gas turbine 2 comprise at least one, in the present example in each case multiple, blade ring(s). Here, in each case multiple rotor blade rings are provided, which rotate together with the respective shaft 20A, 20B, 20C in the housing 21, and multiple guide blade rings, which are arranged so as to be rotationally fixed with respect to the housing 21.

The compressor 23 and/or the turbine 25 comprise(s) a blade ring 1A, 1B or multiple blade rings 1A, 1B as per FIG. 3 and/or FIG. 4, in particular produced by means of the method as per FIG. 1. In this way, the compressor 23 and/or the turbine 25 can be produced from particularly robust materials, and at the same time have a particularly low weight.

### LIST OF REFERENCE SYMBOLS

1 Device
1A, 1B Blade ring
10, 10A, 10B First component
100 Connection region
11, 11A Second component
110 Connection region
12 Intermediate layer
120 Undulations
121 Ground surface
13 Mixing zone
14 Friction-weld seam
2 Gas turbine (turbomachine)
20A Low-pressure shaft
20B Medium-pressure shaft
20C High-pressure shaft
21 Housing
210 Air inlet
211 Air outlet
22 Fan
23 Compressor
230 Medium-pressure compressor
231 High-pressure compressor
24 Combustion chamber
25 Turbine
250 Low-pressure turbine
251 Medium-pressure turbine
252 High-pressure turbine
26 Bypass channel
3 Welding device
30 Powder feed means
31 Laser
H Main flow direction
N Deposition-weld seam
R Axis of rotation

1. A method for joining components, having the following steps:
providing a first component, comprising or composed of a first material;
providing at least one second component, comprising or composed of a second material;
applying an intermediate layer to the second component by means of generative manufacture, in particular by deposition welding; and
connecting the intermediate layer on the second component to the first component by means of welding, in particular friction welding.

2. The method according to claim 1, wherein the first material differs from the second material.

3. The method according to claim 1, wherein the intermediate layer comprises the first material or is composed of the first material.

4. The method according to claim 1, wherein at least one of the first and the second component comprises or is composed of a nickel-based alloy.

5. The method according to claim 1, wherein the first material is Inconel-718 and the second material is CMSX-4.

6. The method according to claim 1, wherein the generative manufacture is laser deposition welding.

7. The method according to claim 1, wherein multiple second components are provided, wherein an intermediate layer is applied to each second component by deposition welding, and the intermediate layer of each second component is connected to the first component by means of friction welding.

8. The method according to claim 1, wherein the subsequent step of weld aftertreatment, in particular comprising heat treatment.

9. The method according to claim 1, wherein the provision of the first component comprises the forging of the first component.

10. The method according to claim 1, wherein the first component is a blade carrier or a part of a blade carrier for a turbomachine.

11. The method according to claim 1, wherein the second component is a blade airfoil for a turbomachine.

12. The method according to claim 1 for producing a blade ring for a turbomachine, characterized in that the first component is provided in the form of a ring or a disk for a turbomachine, and the at least one second component is provided in the form of a blade airfoil, specifically of a compressor blade or of a turbine blade.

13. A device, in particular produced by means of the method according to claim 1, having
a first component, comprising or composed of a first material;
at least one second component, comprising or composed of a second material;
an intermediate layer applied to the second component by means of generative manufacture, in particular by deposition welding; and
a welded connection, in particular in the form of a friction-weld seam, which cohesively connects the intermediate layer on the second component to the first component.

14. The device, in particular according to claim 13, having
a first component, comprising or composed of a first material;
at least one second component, comprising or composed of a second material;
wherein the first material of the first component is cohesively connected to the second material of the second component by means of an intermediate layer and a further layer, in particular a fiction-weld seam,
wherein the intermediate layer is arranged adjacent to the second component and has a first grain size, and the further layer is arranged between the intermediate layer and the first component and has a second grain size smaller than the first grain size, and wherein the first material has a third grain size smaller than the first grain size and larger than the second grain size.

15. The device according to claim 13, wherein the device is formed as a blade ring for a turbomachine and comprises multiple second components in the form of in each case one blade airfoil.

16. The method according to claim 1, wherein the intermediate layer is, after the connection, arranged between the first component and the second component.
